(19) United States
(12) Patent Application Publication
(10) Pub. No.: US 2014/0208967 A1
(43) Pub. Date: Jul. 31, 2014

(54) METHOD FOR CONTROLLING A PARAMETER OF AN INKING UNIT

(71) Applicant: MANROLAND WEB SYSTEMS GMBH, AUGSBURG (DE)

(72) Inventors: STEFAN ALBRECHT, NEUSAESS (DE); NORBERT ROTHENBERGER, NORDENDORF (DE); MARTIN SCHMID, SCHILTBERG (DE); SIMON BERGER, KOENIGSBRUNN (DE)

(73) Assignee: MANROLAND WEB SYSTEMS GMBH, AUGSBURG (DE)

(21) Appl. No.: 14/167,865

(22) Filed: Jan. 29, 2014

(30) Foreign Application Priority Data
Jan. 30, 2013 (DE) 10 2013 100 916.6

(51) Int. Cl. B41F 31/02

(52) U.S. Cl. CPC B41F 31/022
USPC 101/363

(57) ABSTRACT

A method for controlling at least one control parameter from a number of parameters of an inking unit of a printing press is disclosed. Based on at least the control parameter, a value of an ink density on a substrate to be printed by the printing press is calculated by an inking unit model and the calculated value is used as input quantity for controlling instead of an actual value. Here, the calculated value is exclusively calculated based on a number of parameters of the inking unit at least at times.

This application claims the priority of German Patent Document No. DE 10 2013 100 916.6, filed Jan. 30, 2013, the disclosure of which is expressly incorporated by reference herein.

### BACKGROUND AND SUMMARY OF THE INVENTION

The invention relates to a method for controlling at least one control parameter from a number of parameters of an inking unit of a printing press, preferably an offset printing press, wherein based on at least the control parameter a value of an ink density on a substrate to be printed by the printing press is calculated by means of an inking unit model, and the calculated value is used as input quantity for controlling instead of an actual value. Furthermore, the invention relates to a printing press having at least one inking unit, which comprises a control unit for carrying out the method.

The control parameter can, for example, be an opening of an ink blade or a rotational speed of an ink fountain roller. Ink quantity and ink density can thereby be adjusted.

Such methods are employed in printing presses, in particular in offset printing presses, during start-up and production run. In such machines, one or a plurality of inks are applied in succession onto the substrate, typically paper, cardboard or foil. The ink quantity to be applied is dependent, for example, on the subject, on the type of the ink, the quantity of the color pigments contained therein or the personal taste of the customer. In order to minimize waste, i.e., non-saleable copies, and maximize the economy of the printing press, the objective with each printing order is to reach the target quantity of ink on the copy as quickly as possible and keeping it constant during further operation. For this purpose, the operator has various intervention possibilities in the inking unit of the machine at its disposal.

The inking unit of a printing press is based on an ink container, in which the printing ink is stored. From this container, the ink is typically removed with a slowly rotating roller, the ink fountain roller. The ink layer thickness on the fountain roller is determined through actuators, the ink blades. The opening of the ink blades can be typically adjusted zonally, i.e., differently over the substrate width. This is to take into account the ink requirement of the subject that differs over the width.

Depending on the type of design—film inking units and ink feed roller inking units are distinguished—the ink is removed from the ink fountain roller with a roller which rotates at a spacing that is adjusted in a fixed manner, the film roller, or with a roller which is mounted in a vibrating manner, the vibrating roller. Through a multiplicity of further rollers, the ink film is subsequently homogenized. In order to prevent striation, some rollers, the ink oscillators, are additionally moved oscillatingly transversely to the direction of rotation. Through the multiplicity of rollers, the ink film is reduced in its thickness until it reaches its final thickness. In offset printing, the ink application on the substrate is typically approximately 1 μm. The inking unit furthermore has the objective of storing ink and replacing it in the roller frame where ink was removed by the subject.

A possible construction of an inking unit is disclosed, for example, in Wolfgang Walinsky: “Der Rollenoffsetdruck”, First Edition 1995, Fachschriften-Verlag GmbH and Co.kg Fellbach.

For adjusting the ink rate, the operator can typically open and close the ink blades in the individual ink zones or vary the rotational speed of the fountain roller. It must be noted, furthermore, that by using water in the wet offset, the ink density is likewise slightly reduced since the ink is diluted with fountain solution.

Since manual adjusting of the ink density, in particular with highly irregular subjects, is very complicated and difficult and since it takes a very long time until good copies are printed, devices for the automatic controlling of the ink density are known in the prior art. FIG. 1 shows such a control circuit. For controlling the ink density, an achieved actual density 14 is measured at the end of a printing process 16 with sensors or high-resolution cameras in control fields or in the image and compared with a target density 11. A calculated density differential 12 is then used as an input quantity for a controller 15. The controller 15 generates control signals 13, typically values for the opening of the ink blades, and thereby intervenes in the printing process 16. The document DE 698 10 385 discloses a PID-controller as prior art as a typical embodiment for such a controller.

This control circuit works well for usual area coverages during the running production. FIG. 2 shows qualitatively a typical, controlled density curve 21. Following the machine start-up, also called start-up phase, a tolerance band of the ink density is reached after N₂₁ copies and good copies are printed. The copies outside the tolerance band by the target density are not saleable, being waste.

However, such control systems corresponding to the prior art do have some disadvantages.

During the setting-up of the machine, i.e., during the determining of suitable control variables for reaching the desired optical density, a measurement of the optical density is typically not possible or only much later, since for measuring a minimum density on the paper is required. Only once the minimum density has been reached can a trigger mark or a location in the image for evaluating be detected by the sensor device. For as long as the minimum density is undershot, no control is possible because of the absent actual value. This is represented. in FIG. 1 by the switch 17.

With very low area coverages, only very little ink is removed from the inking unit. Depending on the number of the rollers in the inking unit and the ink quantity thereby stored, the inking unit reacts very sluggishly to changes of the adjustment of the ink zones or the fountain roller speed. During uncontrolled operation, a density characteristic 22 then increases only very slowly corresponding to FIG. 2. A very high waste rate is the result, which substantially reduces the economy of the machine.

Furthermore, the simple PID-controller in the controlled operation can result in a severe over-regulation of the ink density, since in the controller very large corrective signals are generated, but the system replies only very sluggishly. Because of the very large corrective signals, ink densities, which are far above the desired ink densities, result from the controller intervention after a certain time. The controller now commences to counter-regulate and the process continues in the reverse direction with renewed under-regulation. FIG. 2 shows the typically controlled density curve with low area coverage with curve 23. Typically, with very low area coverage, no stationary working point of the achieved ink density is created despite the intervention of the controller. On the contrary, according to the prior art, a manual intervention of the operating personnel is required with very low area coverages.

In addition it is possible in modern printing presses to influence the ink flow via the roller group in defined locations through throwing-on and throwing-off, thus reducing the waste. This is shown in FIG. 3 on the example of an inking unit of a reel-fed offset printing press. With respect to the engaging sequence, the throwing-on of a film roller 32 on a fountain roller 31, the throwing-off of application rollers 33 on a plate cylinder 34 and the impression throw-on of blanket cylinders 35 on the substrate web 36 are distinguished. Simple ink density control systems according to FIG. 1 do not utilize the expanded possibility for intervention in the ink flow.

To avoid the known problems, various setting procedures have been additionally developed in order to reach the target density as quickly as possible even without ink density control during the starting-up of the machine. In all cases, the adjusting variables (ink zone opening, ink fountain roller rotational speed and engaging sequence, partly also the machine speed) are statically or quasi-statically preset. Determining the starting sequence and the adjusting values in this case takes place empirically with the objective that the envisaged ink density is thereby reached during stationary operation without further changes of the adjusting variables being required. The documents DE 103 58 172, DE 698 23 638, DE 10 2008 034 943 or DE 697 16 515 disclose corresponding procedures.

In the document DE 10 2005 013 634 it is proposed for shortening the setting-up time to pre-ink the entire inking unit with a constant ink quantity over the width independently of the image to be printed. Adaptation to the print image takes place only after an empirically determined time. For pre-inking, it is proposed in document EP 1 232 862 to open the zones indirectly proportionally to the area coverage during a defined time span. Resetting to the conventional presetting values takes place only following this. Here, the time spans of the individual steps are predetermined in a fixed manner. It has transpired that dynamics particularly with high area coverages however are not adequate. In order to determine the preset parameters as accurately as possible, the respective suitable settings are stored based on the past productions and used for the next setting-up operation. An adjustment of the start-up sequence does not take place in the process.

All these solutions have the disadvantage that the time sequence of the presetting and the engagement sequence are predetermined in a fixed manner. Optimally low waste in all application cases cannot be achieved with such a procedure.

The document EP 1 671 789 discloses a control method for an inking unit, in which an ink density that is measured in marginal regions is modified with the help of a model of the respective inking unit or based on data of the subject. This method works only provided valid measurement values are also available and is thus not suitable for the engaging sequence during the starting-up of an inking unit.

It is an object of the invention to provide a method for controlling at least one parameter on which the ink density in the printing press depends during the start-up and also during the production run. It is an object of the invention furthermore to provide a printing press with an inking unit comprising a control unit for carrying out such a method.

The invention relates to a method for controlling at least one control parameter from a number of parameters of an inking unit of a printing press, preferably of an offset printing press, wherein based on at least the control parameter a value of an ink density on a substrate to be printed by the printing press is calculated by means of an inking unit model, and the calculated value instead of an actual value is used as an input quantity for controlling. Here, the calculated value at least at times is exclusively calculated based on a number of parameters of the inking unit.

The parameters of the inking unit, which can also be control parameters, can for example be an opening of an ink blade or a rotational speed of an ink fountain roller.

It is to be understood that a number within the scope of this application is to mean a value of one or more. It is likewise to be understood that the calculation of a value, which closely corresponds to the ink density, for example the ink thickness, is considered as equivalent to the calculation of the ink density. It is to be understood, furthermore, that a control parameter is to mean a parameter which is controlled by a controller. It is to be understood in addition that the term of the exclusive basing on a number of parameters of the inking unit is to mean in particular that no measurement value of an ink density or a similar quantity is used as input quantity of the model. Despite this, constants, formula, equations, calculation instructions and the like can be used in the model.

Methods according to the invention were considered not embodiable prior to the priority day of this application. The reason for this is that for controlling an inking unit a calculated value of the ink density has to be available in real time. All models known prior to the priority day however are based on system-theoretical models, which are based on the known laws of continuum mechanics and for example on the preservation of mass. For creating such a model, suitable system states for the ink layer thicknesses have to be introduced.

The simplest models are obtained when the investigation is limited to a stationary operating state. Along the surface of a roller, the ink layer thickness between the contact points to adjacent rollers is then assumed as being constant. At the contact points proper, ink is either fed in or removed. For this reason, for creating such a model, the mass balance of the inflowing and outflowing ink flows has to be drawn up for each contact point between two adjacent rollers.

FIG. 4 shows a detail from an inking unit of a reel-fed printing press with entered states of the ink layer thickness. For example, the ink layer on a film roller 41 prior to the contact with a fountain roller 40 has the thickness t₁(1), after the contact with the fountain roller 40 the thickness t₂(2). It transfers a part of this ink layer to a transfer roller 42 through splitting. The transfer roller 42, prior to the contact with a film roller, has an ink layer of the thickness t₄(4), after the contact, an ink layer of the thickness t₃(3). The transfer roller 42 in turn transfers a part of its ink to a roller 43.

Drawing up the mass balance of the inflowing and outflowing ink at the contact point between roller 41 and roller 42 for example according to FIG. 4, the ink layer thickness tᵢₙ,(51) flowing into the gap amounts to:

Tᵢₙ=t₂+t₄ Equation 1

Likewise, the ink layer thickness tₒᵤₜ(52) issuing from the roller gap is calculated as:

tₒᵤₜ=t₃+t₁ Equation 2

Since in the roller gap no ink can be stored, the fed-in ink layer thickness tᵢₙ(51) has to correspond to the discharged ink layer thickness tₒᵤₜ(52):

tᵢₙ=tₒᵤₜ Equation 3

The ratio of the two outflowing ink layer thicknesses t₃(3) and t₁(1) is usually described by a splitting factor k. In the direction of the form cylinder to be inked, i.e., in the example shown in FIG. 4 from roller 41 to roller 42, the k-th part of the ink layer thickness flowing into the roller gap is transferred:

t₃=k (t₂+t₄) Equation 4

Thus, the following ink layer thickness remains on the roller 41:

t₁=(1−k)·(t₂+t₄) Equation 5

Usually, the splitting figures k are assumed with a value near 0.5. Alternatively it is possible to determine the splitting figure k from known measurement results through parameter identification methods.

For the transfer of the ink from the form cylinder to the print cylinder and in particular from the print cylinder onto the substrate, various approaches are known in the prior art, which deviate from Equation 4, e.g., the splitting law by Walker-Fetsko.

The further procedure with the model creation known from the prior art is only briefly sketched in the following.

If the balances of the ink layer thicknesses are drawn up according to Equation 4 and Equation 5 for all contact points between adjacent rollers, one succeeds in determining an equation system which can be solved for the wanted ink layer thicknesses. The layer thicknesses that were achieved during stationary operation can thereby be calculated. The document EP 0 881 076 discloses such a procedure for determining suitable presetting data. In this document, a relationship between the ink density D and the ink layer thickness t on the substrate is additionally assumed.

For a time-dependent, dynamic simulation, which is practically indispensible for a model-based control model, the procedure which is sketched and shown in EP 0 881 076 however is not adequate. Since in the transient case the layer thicknesses on the surface of a roller also change between two contact points over time, additional states have to be taken into account here.

FIG. 5 for example shows the system model that has been expanded for a time-dependent simulation that is already known from FIG. 4. In this example, the ink layer thickness t₃(3) has to be split into an ink layer thickness (3.1) immediately after the contact between roller 41 and roller 42 and into an ink layer thickness (3.2) immediately before the contact between roller 42 and roller 43. Analogously, the remaining ink layer thicknesses are split into a component after the last contact with an adjacent roller and into a component before the contact with the next adjacent roller. Along a roller surface, a point which seen in direction of rotation is subsequent, traps the ink layer density of a point located before that, offset by a dead time T.

For example, the following applies to the roller arrangement in FIG. 5:

t_{3.2} (t)=t_{3.1} (t−T) Equation 6

The dead time T in this case is dependent on the rotary speed of the roller 42 and on the angle between the contact points with the roller 41 and with the roller 43.

If the remaining system states are correspondingly put into relation to one another as well, sufficient equations are available also for the dynamic simulation in order to be able to transiently determine the ink layer thicknesses over the time. For this purpose, a suitable time integration method is to be used.

Tests with such system-theoretical models however have shown that their calculation is highly time-consuming and not possible in real time even on the fastest process computers. A model-based ink density control based on such system-theoretical approaches is therefore not implementable.

Within the scope of the invention it has now been recognized that there are models in which a simulation of the inking unit in real time is possible and which nevertheless offer an adequate accuracy so that a control based on a calculated value supplied by such a model is possible. Accordingly, the control according to the invention is based on such a calculated value.

This produces a number of advantages. For each application case, the optimal inking strategy can be determined and carried out. Because of this, the waste can be minimized and substantial cost advantages result for the customer and user. Furthermore, the controller construction can be substantially simplified. Since so many measurement points per unit time are no longer required, simpler and more cost-effective measuring heads with lower measurement frequency can be utilized. Furthermore, the systems can be traversingly embodied despite faster reaching of the target thickness and the number of the measurement heads can be substantially reduced. This results in substantial cost advantages for the machine manufacturer and above all for the customer. An advantage of this procedure additionally is that the ink density can be determined at any point in time, even when, for example, the printout is not yet adequate for detecting the actual density. For this reason, the method can be used both for starting-up the machine as well as for the production run.

The basis of the control is a simulation model, which calculates the ink density parallel with the process in real time. A control strategy can be subsequently based on the simulated values, with which, for example, intervening in the parameters ink zone opening, ink fountain roller speed, dampening fountain roller speed or engagement sequence can be made. The calculation model can be configured as complex as desired. A restriction is imposed merely through the real time demand, i.e., the simulation of a time step in the model must not be longer than the duration of the real time step.

Preferred as inking unit model is an empirical inking unit model based on a control-specific transmission element. As was recognized by the present inventors, this fulfils the requirements that it is adequately accurate and can nevertheless be handled with respect to calculation.

Preferably, the inking unit model furthermore comprises a dead time element reflecting the runtime of the ink out of an ink container for changing the control parameter up to the reaching of the first contact point with the film roller (32) or with the vibrating roller. The delay, based on the spreading of the ink in the inking unit, can thus be taken into account with finite speed.

Further preferred, the inking unit model furthermore comprises a dead time element reflecting the runtime of a copy between print and measurement. The runtime of the substrate from the point at which it is printed to a possible sensor or a camera can thereby be taken into account.

According to an embodiment, the control-specific transmission element is a PT₁-element. It has been shown that this already supplies good results for a control. According to an embodiment that is alternative to this, the control-specific transmission element is a PT₂-element. In the application, the latter supplies even better results since additional system inertias are taken into account. Such elements take into account the finite response time of the ink density on the substrate to a change of the control parameter, insofar as it also occurs in the theoretical case of the negligibility of the already mentioned dead times.

Particularly preferably, the calculated value during a start-up phase of the inking unit is exclusively calculated based on a number of parameters of the inking unit, namely at least for as long as a measurement value of the ink density on the substrate can be measured. This is typically the case when the ink density is adequately high in order to be accessible to measurement through an employed sensor or a camera. The time taken in order to obtain an ink density that is within a tolerance band can be assumed as start-up phase, as was already described with reference to FIG. 2. Thus, the control according to the invention can be especially used in that time range in which for a lack of availability of useful measurement values, no control has been possible up to now, which in turn can significantly reduce the waste rate.

According to a further development of the invention, a measurement value of the ink density on the substrate is periodically measured after a start-up phase, preferably after respective calculation of a multiplicity of calculated values, for example approximately every 30 seconds and the inking unit model matched based on the measurement value. This can be effected for example in that the calculated value is corrected by an additive value in order to adapt the calculated value at the time of the measurement to the measurement value. Alternatively, a more complex intervention in the inking unit model is also possible. The measurement is preferably made in a zone arranged downstream of the inking unit. Through the synchronization with a measurement value the accuracy of the control can be improved. Compared with a control based on measurement values however sufficiently fewer measurement points are sufficient here, so that substantially less complex measuring equipment is adequate. For example, a sensor can be traversing the printing web in transverse direction in the zone downstream of the inking unit and thus be used for the measurement at multiple points. The use of a less rapid and thus more cost-effective sensor is also sufficient. Such a sensor is shown, for example, in FIG. 3 with reference number 37.

According to a further development, a film roller or vibrating roller of the inking unit is engaged with the ink fountain roller when the calculated value exceeds a predetermined limit value. Likewise, an application roller can be engaged with a plate cylinder when the calculated value exceeds a predetermined limit value. In addition, a blanket cylinder can be engaged with the substrate when the calculated value exceeds a predetermined limit value. Thus, the engagement sequence can be controlled based on the calculated value, which makes possible a more rapid start-up afflicted by fewer waste.

The invention furthermore relates to a printing press, in particular an offset printing press with an inking unit, which comprises at least one ink fountain roller and an associated ink blade. At least a rotational speed of the ink fountain roller and/or an opening of the ink blade are/is adjustable as a control parameter. For the inking unit, a control unit with a controller and an inking unit model, as well as preferably a sensor traversing or not traversing the printing web in transverse direction in a zone arranged downstream of the inking unit are furthermore provided. These are designed in order to carry out a control method according to the invention, in order to at least adjust a rotational speed of the ink fountain roller and/or an opening of the ink blade as control parameter.

The printing press according to the invention utilizes the already mentioned advantages of the method according to the invention.

In the following, an exemplary embodiment of a controller structure with various modifications is described. Here, reference is made to the attached figures, wherein it is mentioned that reference has already been made up to now to the FIGS. 1 to 5.

### BRIEF DESCRIPTION OF THE DRAWINGS

FIG. 1 shows a controller structure according to the prior art;

FIG. 2 shows various curves of the ink density with increasing number of copies;

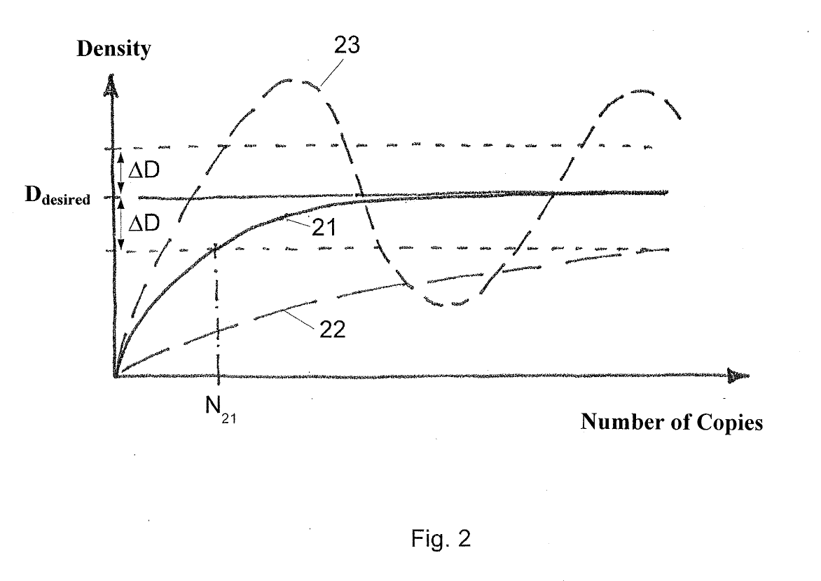

FIG. 3 shows a model of an inking unit;

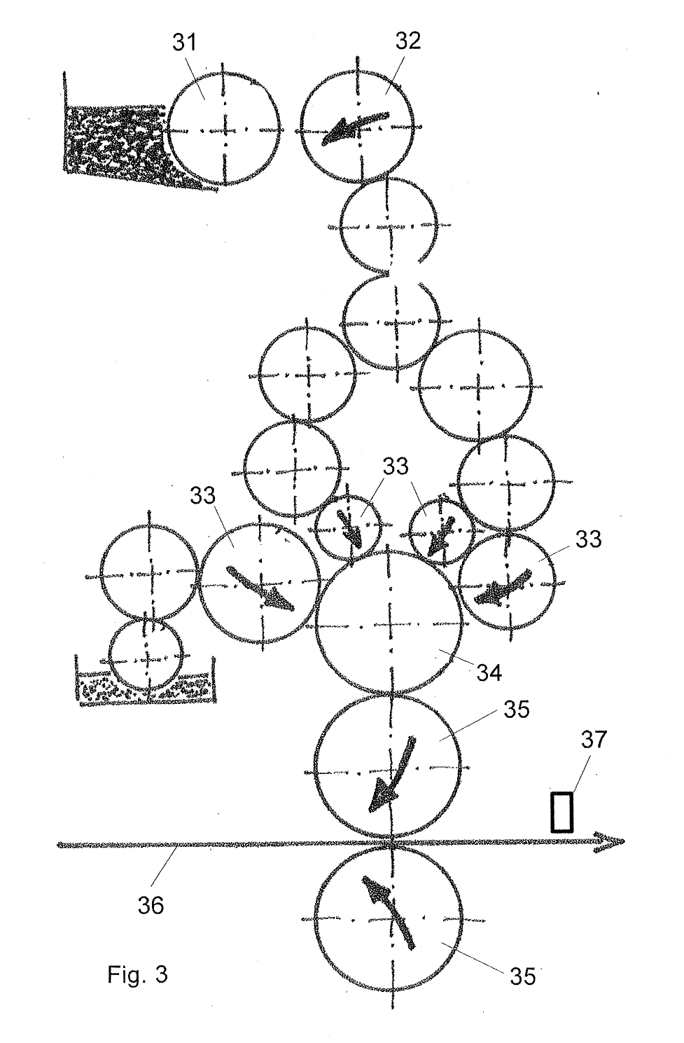

FIG. 4 shows a detail from a model of an inking unit;

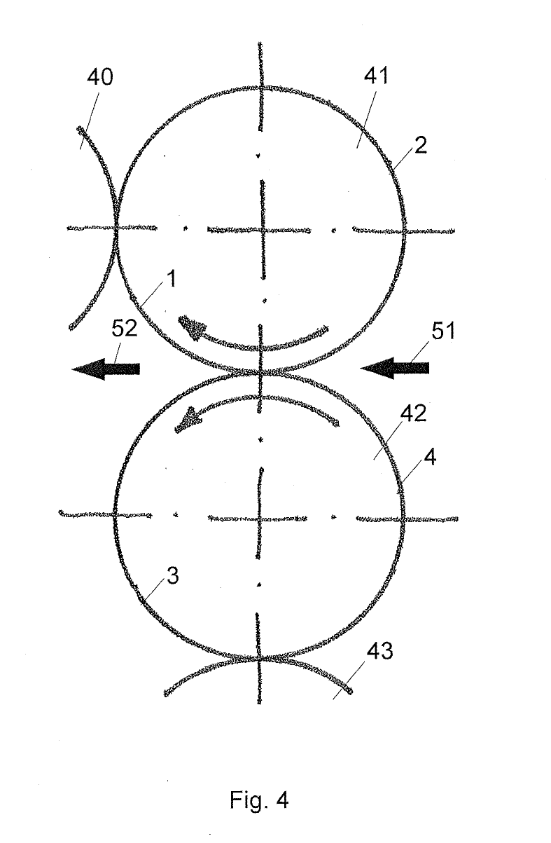

FIG. 5 shows a modified detail from a model of an inking unit;

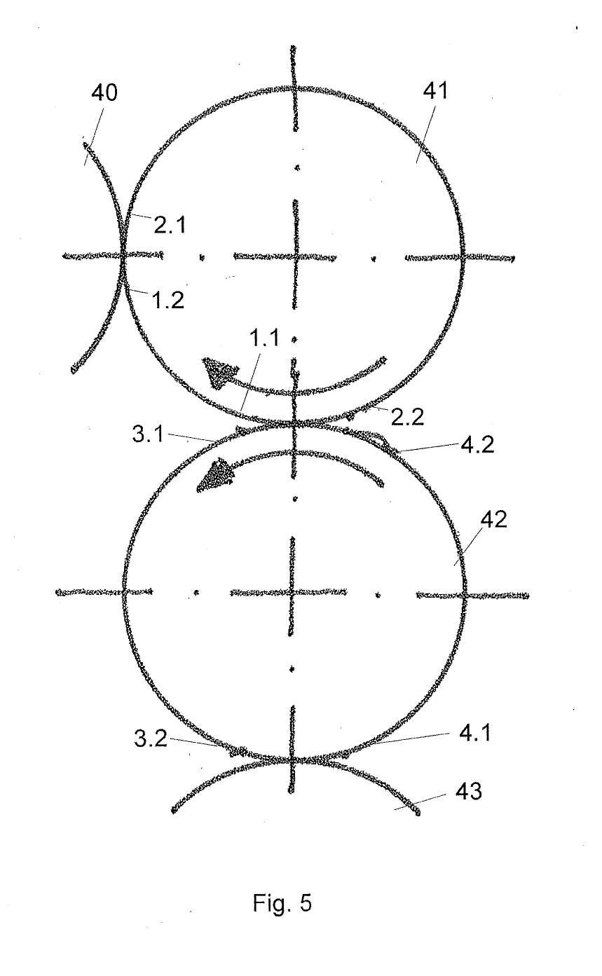

FIG. 6 shows a controller structure according to the invention;

FIGS. 7 to 10 show embodiments of simulation models; and

FIG. 11 shows an engagement sequence.

### DETAILED DESCRIPTION OF THE DRAWINGS

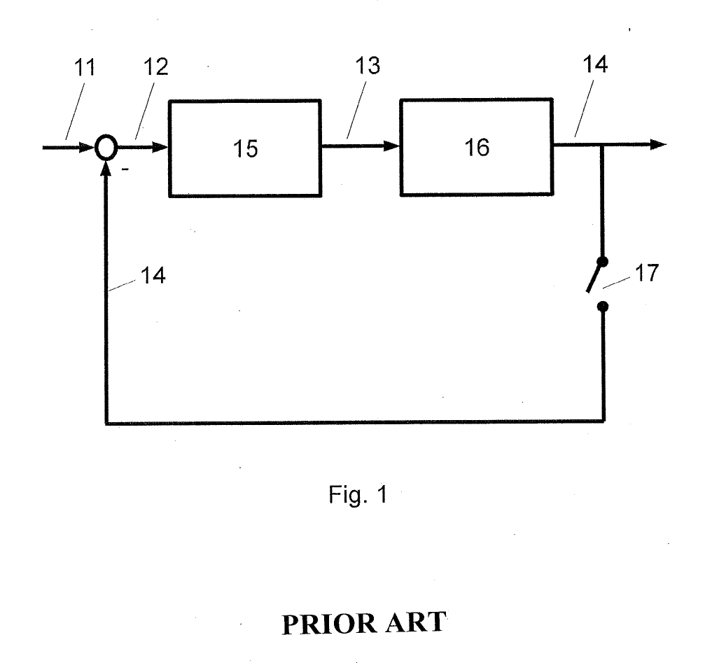

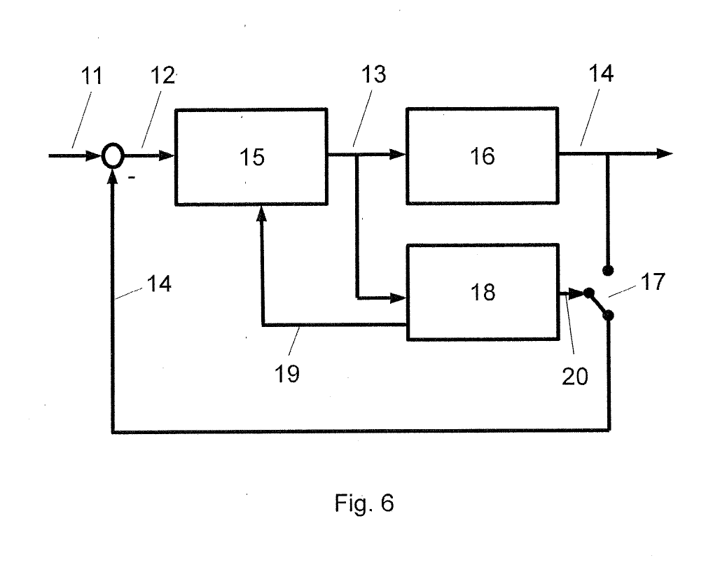

FIG. 6 shows the schematic construction of a controller structure according to the invention. Compared with a controller structure according to the prior art, as shown in FIG. 1, this controller structure is complemented by a simulation model 18. The simulation model 18 makes use of the available process data 13, i.e., of the parameters of the inking unit. These are, for example, the already mentioned, typical parameters opening of one or multiple ink blades, rotational speed of an ink fountain roller, rotational speed of a dampener fountain roller or the engagement state of film roller or vibrating roller, application roller or blanket cylinder. In addition to this, any further process variables, e.g., temperatures, characteristics of paper or ink, dampening unit parameters, characteristics of blankets or other print materials, etc., can be additionally made available for the simulation model. From this data, the simulation model calculates a calculated ink density 20 as estimate of the actual ink density. In the case of a high model quality, the simulated and the real values run approximately identical. For this reason, a conventional control circuit can be set up but which is furnished with the calculated values for comparison with the target value 11.

For the start-up process, the optimal points of time for advancing the engagement sequence can be calculated in addition besides the calculated ink density 20 in the simulation model 18. This information 19 is preferably directly passed on to the controller 15.

During the production run, a discrepancy between actual and calculated ink density can result over an extended period of time. The actual ink density can therefore be measured from time to time with a simple measuring device and the model corrected according to the measurement value. Since the measurement data are merely required at greater time intervals, during which typically a multiplicity of calculated values is calculated, simpler sensor devices or camera systems with lower time resolution can be utilised. Particularly advantageous is the use of the simulation model however in particular during the starting-up of the inking unit since no valid measurement values are available there.

Here, an empirical inking unit model based on an individual control-specific transmission element and additional dead time elements is used as simulation model 18.

Here, the control-specific transmission element is a PT₁ element. This describes the following relationship between the flow rate v′ of the ink flowing into the inking unit and the ink density D, which is achieved on the substrate:

T D′(t)+D(t)=K v′(t) Equation 7

T therein is the time constant of the PT₁-element, K is the amplification factor. Both quantities can be simply identified from measurement data. Alternatively, other quantities, e.g., the ink layer thickness on the substrate instead of the density or the ink layer thickness on the ink fountain roller can also be put into relation instead of the flow rate through the PT₁-element and these quantities suitably recalculated through an additional block.

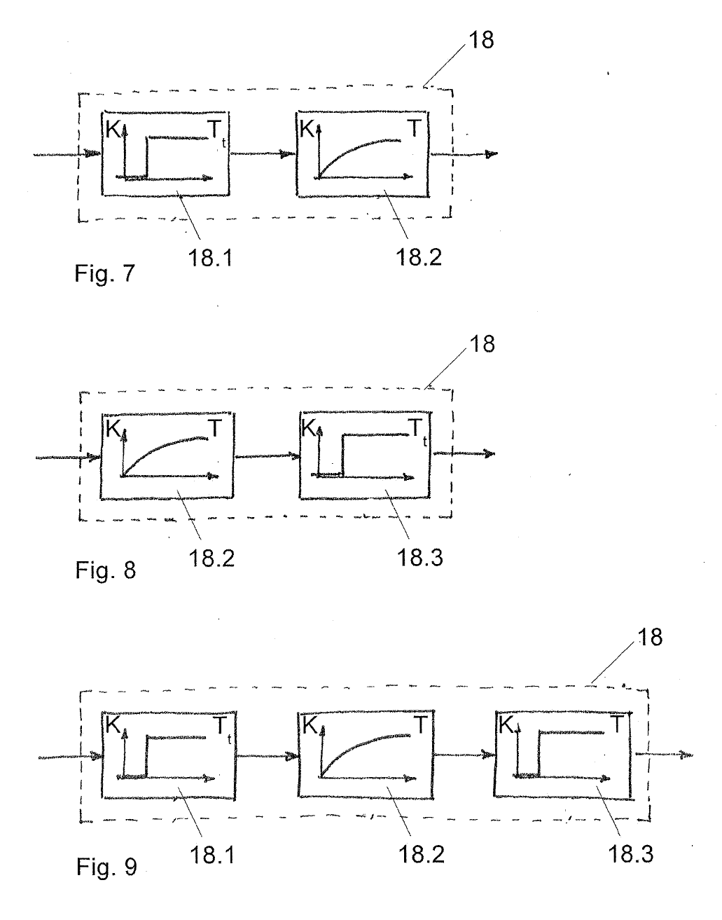

Here, a dead time element 18.1 is additionally provided according to FIG. 7 for the empirical inking unit model in a first embodiment. The dead time element 18.1 detects the time from the setting of the ink blade or from the changing of the rotational speed of the ink fountain roller up to the reaching of the first contact point either with the film roller or with the vibrating roller. Owing to the slow-rotating fountain roller it is advantageous when this dead time is not neglected in the calculation model.

For machines with a longer transport section between printing unit and the measurement location of the ink density an additional dead time element 18.3 is required after the PT₁-element 18.2 according to FIG. 8 for taking into account the time shift between printing and measurement in an alternative embodiment.

Both embodiments can also be combined into a third embodiment according to FIG. 9 with a PT₁-element 18.2 and with two dead time elements 18.1, 18.3.

To exactly describe the dynamic behaviour of an inking unit, typically approximately 10 to 40 parameters are required, even more for large inking units. Test of the inventors have shown that the behaviour of the inking unit can already be very favourably approximated with a PT₁-element despite this.

In order to approximate the real behaviour even better, a PT₂-element can however be also alternatively employed instead of the PT₁-element. This PT₂-element describes the following relationship between the flow rate of the ink v′ flowing into the inking unit and the ink density D that is achieved on the substrate:

T² D″(t)+2 d T D′(t)+D(t)=K v′(t) Equation 8

As additional model parameter, this includes the damping d. Here, too, the state variables D(t) and v′(t) can be replaced with equivalent quantities, e.g., ink layer thicknesses.

FIG. 10 shows the simulation model 18 with a PT₂-element 18.2 and with two dead time elements 18.1, 18.3 analogously to FIG. 9. It is mentioned that the two embodiments according to FIG. 7 and FIG. 8 are also combined with a PT₂-element instead of a PT₁-element.

In contrast with the classic controller, not only the classic parameter such as for example opening of the ink blade or rotational speed of an ink fountain roller can be influenced. On the contrary, it is also possible to intervene directly in the engagement sequence of the machine based on known states.

For this reason, limit values can be defined as a function of the target density, at which the ink layer thickness is at a suitable ratio with respect to the target thickness or the ink density at a suitable ratio to the target density on the respective rollers, and at which an engagement process is then triggered. Ideally, the limit values are in a range between 50% and 95% of the calculated target thicknesses or target densities to be achieved.

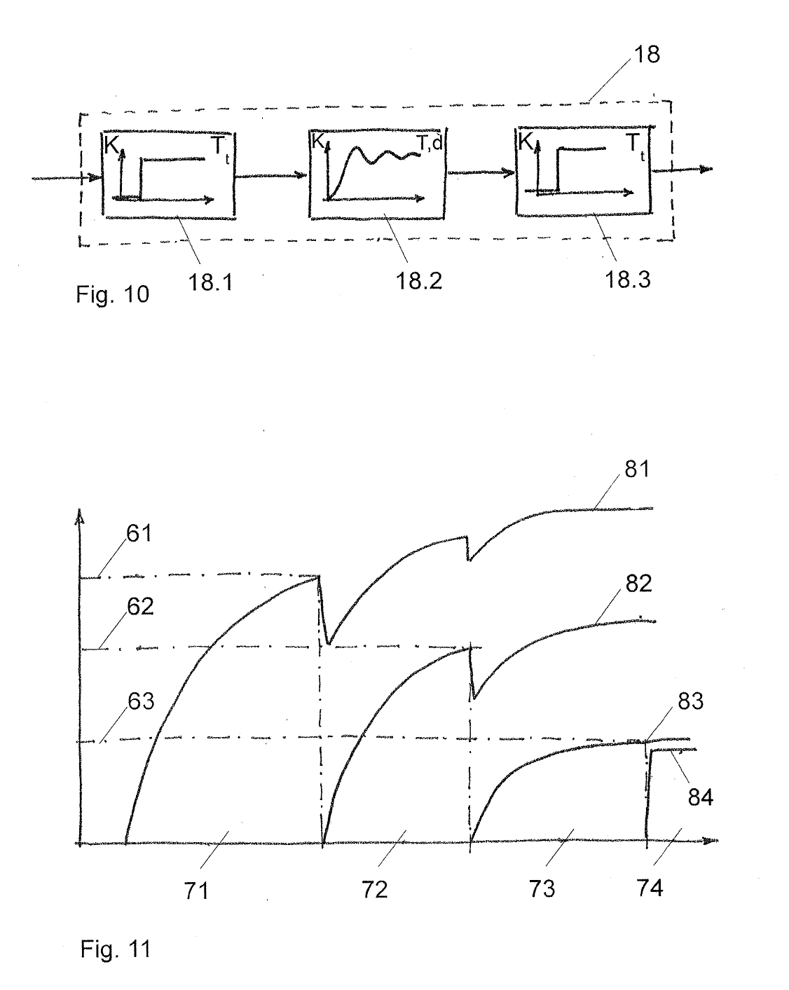

FIG. 11 exemplarily shows an engagement sequence according to the invention, such as is possible with a model-based control. Qualitatively shown over the time is the ink layer quantity on the ink fountain roller (reference number 81), on the application rollers (reference number 82), on the form cylinder (reference number 83) and on the substrate (reference number 84). The limit values for the engaging of the film or vibrating roller (reference number 61), for the engaging of the application rollers with the plate cylinder (reference number 62) and for print on (reference number 63) are likewise drawn in. These are in the abovementioned range between 50% and 95% of the expected target ink thicknesses on the respective rollers. In the time range 71, only ink is present on the ink fountain roller, in the time range 72 also in the roller frame. In the time range 73, the print form is also inked. Only in the time range 74 is ink applied onto the substrate.

Through an engagement sequence that is dependent on the ink layer thickness, the print onto the substrate, in contrast with the usual time-controlled engagement sequence, is delayed so long until the calculated ink quantity on the form cylinder gives rise to the expectation that the target density or at least its tolerance band is reached. This time delay can be separately calculated for all ink zones. In the case of different ink trapping in different ink zones, the target density is then reached in all zones at the same time. In the case of an adequate model quality, setting-up of the printing press is thus possible without waste based on insufficient ink density.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling at least one control parameter from a number of parameters of an inking unit of a printing press, wherein based on at least the control parameter, a calculated value of an ink density on a substrate to be printed by the printing press is calculated by an inking unit model, and wherein, instead of an actual value, the calculated value is used as an input quantity for controlling, and wherein at least at times the calculated value is exclusively calculated based on a number of parameters of the inking unit.

2. The method according to claim 1, wherein a control parameter is a rotational speed of an ink fountain roller.

3. The method according to claim 1, wherein a control parameter is an opening of at least one ink blade.

4. The method according to claim 1, wherein the inking unit model is an empirical inking unit model based on a control-specific transmission element.

5. The method according to claim 4, wherein the inking unit model includes a dead time element reflecting a runtime of an ink out of an ink container from a changing of the control parameter up to reaching of a first contact point with a film roller or with a vibrating roller.

6. The method according to claim 4, wherein the inking unit model includes a dead time element reflecting a runtime of a copy between printing and measurement.

7. The method according to claim 4, wherein the control-specific transmission element is a PT₁-element.

8. The method according to claim 4, wherein the control-specific transmission element is a Pt₂-element.

9. The method according to claim 1, wherein during a start-up phase of the inking unit the calculated value is calculated exclusively based on a number of parameters of the inking unit.

10. The method according to claim 1, wherein after a start-up phase of the inking unit a measurement value of the ink density on the substrate is periodically measured in a zone arranged downstream of the inking unit and wherein the inking unit model is matched based on the measurement value.

11. The method according to claim 10, wherein a sensor in the zone arranged downstream of the inking unit measures the measurement value in a transverse direction of the substrate.

12. The method according to claim 1, wherein a film or vibrating roller of the inking unit is engaged with an ink fountain roller when the calculated value exceeds a predetermined limit value.

13. The method according to claim 1, wherein an application roller is engaged with a plate cylinder when the calculated value exceeds a predetermined limit value.

14. The method according to claim 1, wherein a blanket cylinder is engaged with the substrate when the calculated value exceeds a predetermined limit value.

15. The method according to claim 1, wherein the printing press is an offset printing press.

16. A printing press, comprising:
an inking unit, which comprises at least one ink fountain roller and an ink blade, wherein at least one of a rotational speed of the ink fountain roller and an opening of the ink blade is adjustable as a control parameter; and
a control unit coupled to the inking unit with a controller and an inking unit model, wherein the control unit controls the inking unit by a control method according to claim 1 to adjust at least one of the rotational speed of the ink fountain roller and the opening of the ink blade.

17. The printing press according to claim 16, wherein the printing press is an offset printing press.

18. A method for controlling a printing press, comprising the steps of:
calculating a value of an ink density producible by an inking unit by an inking unit model based exclusively on a control parameter of the inking unit of the printing press; and
using the calculated value as an input for controlling the inking unit instead of using a measured value of an ink density produced by the inking unit.

19. A printing press, comprising:
an inking unit;
a controller coupled to the inking unit; and
an inking unit model coupled to the controller, wherein the inking unit model calculates a value of an ink density producible by the inking unit based exclusively on a control parameter of the inking unit and wherein the calculated value is used as an input to the controller for controlling the inking unit instead of using a measured value of an ink density produced by the inking unit.
